(19) United States
(12) Patent Application Publication
(10) Pub. No.: US 2009/0074623 A1
(43) Pub. Date: Mar. 19, 2009

(54) MICROFLUIDIC DEVICE

(75) Inventors: Chin-sung PARK, Yongin-si (KR); Kak NAMKOONG, Seoul (KR); Young-sun LEE, Yongin-si (KR); Joo-won RHEE, Daejeon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/056,311

(22) Filed: Mar. 27, 2008

(30) Foreign Application Priority Data
Sep. 19, 2007 (KR) 10-2007-0095412

(51) Int. Cl. B01L 3/00

(52) U.S. Cl. 422/100

(57) ABSTRACT

Provided is a microfluidic device including a substrate; a chamber formed by a groove in a bottom surface of the substrate, whereby a fluid can be accommodated in the chamber; and an adhesive tape adhered to the bottom surface of the substrate, wherein the adhesive tape includes a polymer film and a silicone adhesive agent coated on the polymer film.

### CROSS-REFERENCE TO RELATED PATENT APPLICATION

This application claims the benefit of Korean Patent Application No. 10-2007-0095412, filed on Sep. 19, 2007 in the Korean Intellectual Property Office, the disclosure of which is incorporated herein in its entirety by reference.

### BACKGROUND OF THE INVENTION

1. Field of the Invention

The present invention relates to microfluidics, and more particularly, to a microfluidic device that performs a biochemical reaction using a small amount of a biochemical fluid and detects the result of the biochemical reaction.

2. Description of the Related Art

In microfluidic engineering, research is being actively conducted on microfluidic devices having various functions such as performing biochemical reactions using biochemical fluids such as blood and urine and detecting the results of the reactions. Such microfluidic devices include a chip-formed device known as a lab-on-a-chip, or a disk-shaped device that is rotatable and known as a lab-on-a-disk. A microfluidic device includes a chamber in which a fluid is accommodated and a channel that is connected to the chamber.

FIG. 1 is a cross-sectional view of a conventional microfluidic device 10 for a polymerase chain reaction (PCR).

Referring to FIG. 1, the conventional microfluidic device 10 includes a lower substrate 11 and an upper substrate 15 that are attached to each other and a chamber 20 inside. The microfluidic device 10 is used to perform a polymerase chain reaction (PCR) using a biochemical fluid accommodated in the chamber 20. In this regard, the microfluidic device 10 and can also be referred to a “PCR chip.” In order to perform PCR, the biochemical fluid accommodated in the microfluidic device 10 needs to be heated in regular cycles, and thus the process of PCR is also known as “thermal cycling”. A PCR using the microfluidic device 10 can be completed in a shorter time than a conventional PCR process in which a biochemical fluid is injected into a tube to perform PCR. Thus the frequency of use of microfluidic devices such as the microfluidic device 10 is increasing.

The lower substrate 11 is formed of silicon (Si) having excellent thermal conductivity so that thermal conduction can occur in regular cycles and at high speed. The result of a PCR occurring in the biochemical fluid accommodated in the chamber 20 is detected using a fluorescence detection method, and thus the upper substrate 15 of the microfluidic device 10 is formed of a transparent glass. The fluorescence detection method can be used to detect the process of the biochemical reaction in real-time by detecting a fluorescence signal emitting light in a biochemical fluid. However, as described above, since the lower substrate 11 is formed of Si and the upper substrate 15 is formed of glass, the manufacturing cost of the microfluidic device 10 is increased.

### SUMMARY OF THE INVENTION

The present invention provides a microfluidic device with reduced manufacturing costs and with which fast and accurate thermal conduction can occur.

According to an aspect of the present invention, there is provided a microfluidic device comprising: a substrate; a chamber formed by a groove in a bottom surface of the substrate, whereby a fluid can be accommodated in the chamber; and an adhesive tape adhered to the bottom surface of the substrate, wherein the adhesive tape comprises a polymer film and a silicone adhesive agent coated on the polymer film.

The microfluidic device may further comprise a channel that is formed in the bottom surface of the substrate and connected to the chamber.

The microfluidic device may further comprise an inlet hole that is connected to the channel and opened to an upper surface of the substrate in order to inject a fluid, or an outlet hole to discharge air from the chamber to the outside when injecting a fluid.

The substrate may comprise a polymer.

The polymer may be one selected from the group consisting of polydimethylsiloxane (PDMS), polypropylene (PP), polycarbonate (PC), polyethylene (PE), polyethylene terephthalate (PET), polymethylmethacrylate (PMMA), cyclic olefin copolymer (COC), silicone, and urethane resin.

The polymer film of the adhesive tape may be formed of one selected from the group consisting of polypropylene (PP), polycarbonate (PC), polyethylene (PE), polyethylene terephthalate (PET), polymethylmethacrylate (PMMA), and cyclic olefin copolymer (COC).

The thickness of the adhesive tape may be 30 to 100 μm.

The microfluidic device may be used for a polymerase chain reaction (PCR) of a biochemical fluid.

The substrate may be transparent so that the PCR can be detected in real-time using an optical method.

According to the present invention, a polymer-based microfluidic device can be manufactured without using expensive silicon wafer.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional microfluidic device for polymerase chain reaction (PCR);

FIG. 2 is a perspective view of a microfluidic device according to an embodiment of the present invention;

FIG. 3 is a cross-sectional view of the microfluidic device of FIG. 2 cut along a line A-A′ in FIG. 2, according to an embodiment of the present invention; and

FIG. 4 is a cross-sectional view of a portion B illustrated in FIG. 3, according to an embodiment of the present invention.

### DETAILED DESCRIPTION OF THE INVENTION

The present invention will now be described more fully with reference to the accompanying drawings, in which exemplary embodiments of the invention are shown.

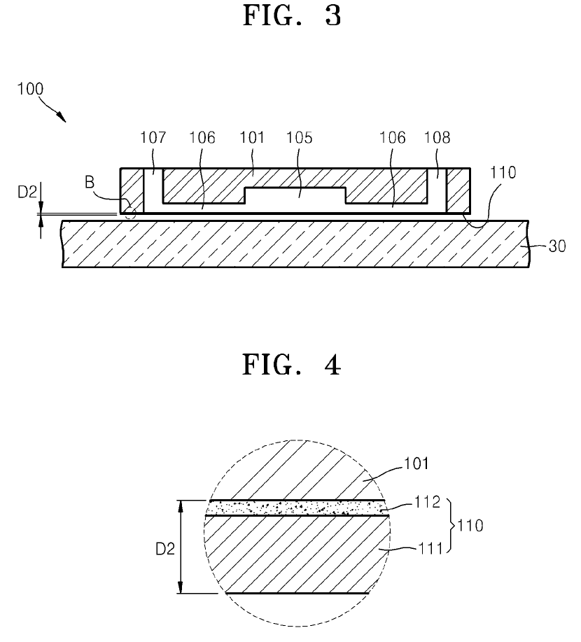

FIG. 2 is a perspective view of a microfluidic device 100 according to an embodiment of the present invention. FIG. 3 is a cross-sectional view of the microfluidic device 100 of FIG. 2 cut along a line A-A′ in FIG. 2, according to an embodiment of the present invention. FIG. 4 is a cross-sectional view of a portion B illustrated in FIG. 3, according to an embodiment of the present invention.

Referring to FIGS. 2 and 3, the microfluidic device 100 according to an embodiment of the present invention includes a substrate 101, a chamber 105, a channel 106, and an adhesive tape 110. The chamber 105 and the channel 106 are formed of a groove in a bottom surface of the substrate 101, and the adhesive tape 110 is attached to the bottom surface of the substrate 101. The microfluidic device 100 is designed to perform a polymerase chain reaction (PCR), and the substrate 101 may be preferably formed of a polymer that is cheaper and can be manufactured more easily than silicon (Si) or glass. The polymer used to form the substrate 101 may be polydimethylsiloxane (PDMS), polypropylene (PP), polycarbonate (PC), polyethylene (PE), polyethylene terephthalate (PET), polymethylmethacrylate (PMMA), cyclic olefin copolymer (COC), silicone, or urethane resin. In addition, the substrate 101 is transparent so that a PCR can be detected in real-time using an optical method.

The chamber 105 and the channel 106 formed in the substrate 101 can be formed by machining the bottom surface of the substrate 101 that is flat, or by injecting a fluid resin into a mold for forming the substrate 101, wherein the mold includes a structure corresponding to the chamber 105 and the channel 106, and hardening the fluid resin. The PCR of a biochemical fluid can be induced and the result of the PCR can be detected in the chamber 105, and the channel 106 is connected to the chamber 105.

An inlet hole 107 and an outlet hole 108 connected to respective ends of the channel 106 and opened to an upper surface of the substrate 101 are formed in the substrate 101. The inlet hole 107 is for injecting a biochemical fluid into the microfluidic device 100, and the outlet hole 108 is for discharging air from the chamber 105 when injecting a fluid. The inlet hole 107 and the outlet hole 108 can be formed by machining the substrate 101.

The adhesive tape 110 covers the bottom surface of the substrate 101 so that the chamber 105, the channel 106, the inlet hole 107, and the outlet hole 108 are not opened at the bottom of the substrate 101. Accordingly, a biochemical fluid (not shown) injected into the microfluidic device 100 through the inlet hole 107 does not flow downward and is accommodated in the channel 106 and the chamber 105.

Referring to FIG. 4, the adhesive tape 110 includes a polymer film 111, and a silicone adhesive agent 112 coated on the polymer film 111. The polymer film 111 is flexible, and may be formed of polypropylene (PP), polycarbonate (PC), polyethylene (PE), polyethylene terephthalate (PET), polymethylmethacrylate (PMMA), or cyclic olefin copolymer (COC).

If the adhesive agent 112 reacts with a material contained in the biochemical fluid or the materials contained in the biochemical fluid adhere to the adhesive agent 112, a biochemical reaction may not occur to a desired degree or the result of the biochemical reaction may not be detected easily. Thus, the adhesive agent 112 is preferably formed of a silicone material that barely reacts with materials contained in the biochemical fluid.

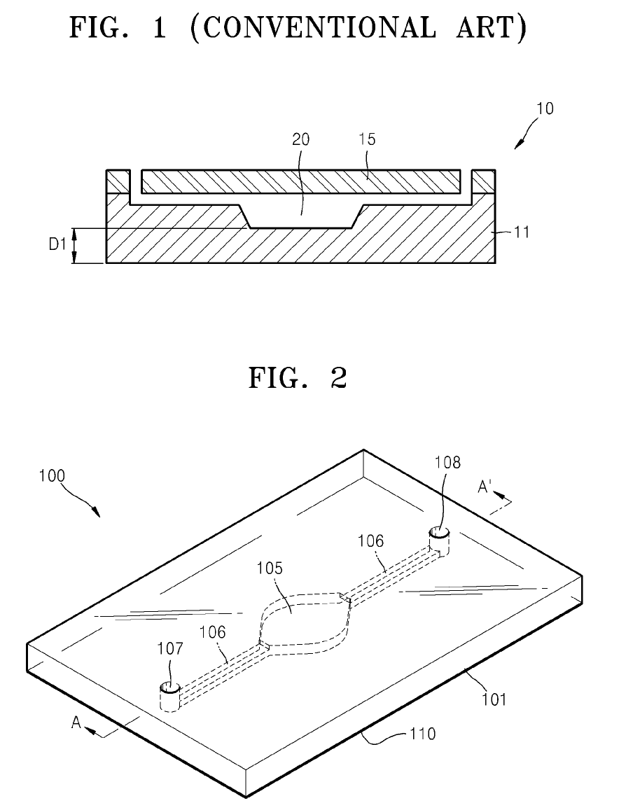

Referring to FIG. 3 again, as described with reference to the conventional art, performing a PCR is also known as “thermal cycling”, and in the conventional art, the lower substrate 11 (see FIG. 1) contacting a microheater 30 (refer to FIG. 3) is formed of silicon (Si) so that fast thermal conduction can occur in regular cycles. Silicon (Si) has a thermal conductivity k of 157 W/m/K, which is much higher than polymer. Accordingly, when a thickness D2 of the adhesive tape 110 of the microfluidic device 100 according to the current embodiment of the present invention is set to be the same as a thickness D1 of a portion of the conventional microfluidic device 10 of FIG. 1 from the bottom surface of the lower substrate 11 to the bottom of the chamber 20, a microfluidic device that can be used for a PCR cannot be manufactured. Consequently, the thickness D2 of the adhesive tape 110 should be much smaller than the thickness D1.

The non-dimensionalized transient heat conduction equation is as follows, where a non-dimensional coefficient θ*, x*, and F_{O} in Equation 1 are defined as in Equation 2.

$$\begin{matrix}\frac{\partial {θ}^{*}}{\partial {F}_{O}} = \frac{{\partial }^{2} {θ}^{*}}{\partial {x}^{* 2}} & [ Equation 1 ] \\ {θ}^{*} = \frac{T - {T}_{∞}}{{T}_{i} - {T}_{∞}} , {x}^{*} = \frac{x}{L} , {F}_{O} = \frac{t}{{L}^{2} / α} , & [ Equation 2 ]\end{matrix}$$

where L²/α is a conduction time scale. L denotes the thickness of a thermal conductor contacting a heater, and α denotes thermal diffusivity. The conduction time scale is defined as in Equation 3.

conduction time scale=ρCₚL²/k, [Equation 3]

where k is thermal conductivity of a thermal conductor contacting a heater, ρ is density of the thermal conductor, and Cₚ is specific heat of the thermal conductor.

The thickness D2 of the adhesive tape 110 is preferably set such that the conduction time scale of the lower substrate 11 of the conventional microfluidic device 10 (see FIG. 1) which is formed of Si, and the conduction time scale of the adhesive tape 110 of the microfluidic device 100 according to the current embodiment of the present invention do not vary from each other too much. Thus, the microfluidic device 100 according to the current embodiment of the present invention can be used for a PCR despite the great difference in thermal conductivity k between the conventional microfluidic device 10 and the microfluidic device 100 according to the current embodiment of the present invention.

The inventors have calculated the conduction time scale according to the thickness of COC that can be used to form the polymer film 111 (see FIG. 4) of the adhesive tape 110 according to the current embodiment of present invention by applying Equation 3. Here, thermal conductivity k of COC was 0.135 W/m/K, density ρ was 1020 kg/m³, and specific heat Cₚ was 1000 J/kg/K. Accordingly, when the thickness D2 of the adhesive tape 110 was varied in the range of 10 μm to 100 μm, the conduction time scale of the adhesive tape 110 was varied in the range of 0.756 msec to 75.6 msec.

Meanwhile, the thickness D1 of the portion of the conventional microfluidic device 10 from the bottom surface of the lower substrate 11 to the bottom of the chamber 20 is 350 μm, and the thermal conductivity k is 157 W/m/K, density ρ is 2329 kg/m³, and specific heat Cₚ is 700 J/kg/K, and thus the conduction time scale of the portion of the conventional microfluidic device 10 from the bottom surface of the lower substrate 11 to the bottom of the chamber 20 is 1.27 msec.

When the thickness D2 of the adhesive tape 110 of the microfluidic device 100 is about 10 μm, the conduction time scale is better than that of the conventional microfluidic device 10 (see FIG. 1); however, the physical rigidity of the adhesive tape 110 having such a thickness is too weak and thus the adhesive tape 110 cannot stand the high temperature and high pressure conditions during a biochemical reaction, and thus requires very cautious treatment. The inventors have discovered that the thickness D2 of the adhesive tape 110 has sufficient physical rigidity to stand the high temperature and high pressure conditions during a biochemical reaction when the thickness D2 of the adhesive tape 110 is 30 μm or greater. When the thickness D2 of the adhesive tape 110 is greater than 100 μm, the conduction time scale thereof is too great and thus a PCR cannot be completed within the same period of time as the conventional microfluidic device 10. Accordingly, the thickness D2 of the adhesive tape 110 may be preferably 30 to 100 μm.

A PCR occurring in the chamber 105 of the microfluidic device 100 can be analyzed in real-time by detecting a fluorescence signal that is emitted from the biochemical fluid accommodated in the chamber 105. Such analysis of a biochemical reaction by detecting a fluorescence signal is known as a fluorescence detection method. Examples of the fluorescence detection method used for the analysis of a PCR include a method of using a dye such as SYBR Green 1 that emits a fluorescence when the dye is bonded to a double stranded DNA that is generated by the PCR, a method of using a DNA sequence as a probe and the phenomenon that a fluorescence is generated as the bond between a fluorophore and a quencher at the end of the probe is broken, and so forth. Since the fluorescence detection method of PCR is well known in the art, a detailed description thereof will not be provided here. The inventors have used the fluorescence detection method to analyze PCRs of the conventional microfluidic device 10 and of the microfluidic device 100 according to the current embodiment of the present invention in which the adhesive tape 110 has a thickness D2 of 70 μm and found similar results from both microfluidic devices. Thus, it was proved that the microfluidic device 100 according to the current embodiment of the present invention can be applied to analysis of PCRs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A microfluidic device comprising:
a substrate;
a chamber formed by a groove in a bottom surface of the substrate, whereby a fluid can be accommodated in the chamber; and
an adhesive tape adhered to the bottom surface of the substrate,
wherein the adhesive tape comprises a polymer film and a silicone adhesive agent coated on the polymer film.

2. The microfluidic device of claim 1, further comprising a channel that is formed in the bottom surface of the substrate and connected to the chamber.

3. The microfluidic device of claim 2, further comprising an inlet hole that is connected to the channel and opened to an upper surface of the substrate in order to inject a fluid, or an outlet hole to discharge air from the chamber to the outside when injecting a fluid.

4. The microfluidic device of claim 1, wherein the substrate comprises a polymer.

5. The microfluidic device of claim 4, wherein the polymer is one selected from the group consisting of polydimethylsiloxane (PDMS), polypropylene (PP), polycarbonate (PC), polyethylene (PE), polyethylene terephthalate (PET), polymethylmethacrylate (PMMA), cyclic olefin copolymer (COC), silicone, and urethane resin.

6. The microfluidic device of claim 1, wherein the polymer film of the adhesive tape is formed of one selected from the group consisting of polypropylene (PP), polycarbonate (PC), polyethylene (PE), polyethylene terephthalate (PET), polymethylmethacrylate (PMMA), and cyclic olefin copolymer (COC).

7. The microfluidic device of claim 1, wherein the thickness of the adhesive tape is 30 to 100 μm.

8. The microfluidic device of claim 1, wherein the microfluidic device is used for a polymerase chain reaction (PCR) of a biochemical fluid.

9. The microfluidic device of claim 8, wherein the substrate is transparent so that the PCR can be detected in real-time using an optical method.
